(19) United States
(12) Patent Application Publication
(10) Pub. No.: US 2018/0037226 A1
(43) Pub. Date: Feb. 8, 2018

(54) VEHICLE TRAVELING CONTROL APPARATUS

(71) Applicant: TOYOTA JIDOSHA KABUSHIKI KAISHA, Toyota-shi (JP)

(72) Inventors: Hirotada OTAKE, Susono-shi (JP); Masaki Takano, Susono-shi (JP)

(73) Assignee: TOYOTA JIDOSHA KABUSHIKI KAISHA, Toyota-shi (JP)

(21) Appl. No.: 15/489,959

(22) Filed: Apr. 18, 2017

(30) Foreign Application Priority Data
Aug. 8, 2016 (JP) 2016-155799

(51) Int. Cl. B60W 30/16; B60W 10/04; B60W 50/00; B60W 10/18

(52) U.S. Cl. CPC B60W 30/16; B60W 10/18; B60W 10/04; B60W 50/0098; B60W 2040/0818

(57) ABSTRACT

A vehicle traveling control apparatus of the invention executes a following-travel inter-vehicle-distance control for controlling acceleration and deceleration of an own vehicle such that an inter-vehicle distance between the own vehicle and a preceding vehicle is maintained at a target distance. The apparatus sets the target distance to a base distance and executes the following-travel inter-vehicle-distance control when the driver is determined not to be under the abnormal state. The apparatus sets the target distance to an increased distance larger than the base distance and executes the following-travel inter-vehicle-distance control when the driver is determined to be under the abnormal state.

### BACKGROUND OF THE INVENTION

### Field of the Invention

The invention relates to a vehicle traveling control apparatus for braking a vehicle to stop the vehicle when a driver of the vehicle is under an abnormal state that the driver loses an ability of driving the vehicle.

### Description of the Related Art

There is proposed an apparatus which determines whether or not a driver of a vehicle is under an abnormal state that the driver loses an ability of driving the vehicle, for example, a state that the driver sleeps and a state that a mind and body function of the driver stops and which brakes the vehicle to stop the vehicle when determining that the driver is under the abnormal state (refer to WO 2012/105030).

Hereinafter, this apparatus will be referred to as “the conventional apparatus”.

When the driver under the normal state is determined to be under the abnormal state that the driver loses an ability of driving the vehicle and then, the conventional apparatus stops the vehicle, the vehicle is unnecessarily stopped.

The invention has been made for solving the aforementioned problem. An object of the invention is to provide a vehicle traveling control apparatus which can prevent the vehicle from being stopped unnecessarily when the driver under the normal state is determined to be under the abnormal state.

A vehicle traveling control apparatus according to the invention (hereinafter, will be referred to as “the invention apparatus”) can execute a following-travel inter-vehicle-distance control (refer to a routine shown in FIG. 3) for controlling acceleration and deceleration of an own vehicle, to which the invention apparatus is applied, such that an inter-vehicle distance (Dfx(a)) between the own vehicle and a preceding vehicle traveling in front of the own vehicle is maintained at a target inter-vehicle distance (Dtgt).

The invention apparatus comprises an electric control unit (10, 30, 40). The electric control unit (10, 30, 40) is configured to continuously determine whether or not a driver of the own vehicle is under an abnormal state that the driver loses an ability of driving the own vehicle (refer to processes of a step 415 in FIG. 4, a step 510 in FIG. 5 and a step 615 in FIG. 6) during an execution of the following-travel inter-vehicle-distance control (refer to a determination “Yes” at a step 410 in FIG. 4). The electric control unit (10, 30, 40) is further configured to stop the following-travel inter-vehicle-distance control (refer to a process of a step 520 in FIG. 5) and execute a forced stop control for stopping the own vehicle by braking the own vehicle (refer to a process of a step 625 in FIG. 6) when the driver continues to be determined to be under the abnormal state for a predetermined time (T1th+T2th+T3th) (refer to a determination “Yes” at a step 625 in FIG. 6) after the electric control unit (10, 30, 40) determines that the driver is under the abnormal state (refer to a determination “Yes” at the step 515 in FIG. 5). The electric control unit (10, 30, 40) is further configured to determine that the driver is under a normal state (refer to determinations “No” at the step 415 in FIG. 4, the step 510 in FIG. 5 and the step 615 in FIG. 6) when an acceleration operator (11a) of the own vehicle is operated after the electric control unit (10, 30, 40) determines that the driver is under the abnormal state (refer to the determinations “Yes” at the step 415 in FIG. 4, the step 510 in FIG. 5 and the step 615 in FIG. 6).

The electric control unit (10, 30, 40) is further configured to set the target inter-vehicle distance (Dtgt) to a base inter-vehicle distance (Dbase) (refer to a process of a step 340 in FIG. 3) and execute the following-travel inter-vehicle-distance control (refer to processes of steps 350 and 360 in FIG. 3) when the electric control unit (10, 30, 40)) determines that the driver is not under the abnormal state (refer to the determinations “No” at the step 510 in FIG. 5 and the step 615 in FIG. 6 and a determination “Yes” at a step 330 in FIG. 3) during the execution of the following-travel inter-vehicle-distance control (refer to a determination “Yes” at a step 310 in FIG. 3).

The electric control unit (10, 30, 40) is further configured to set the target inter-vehicle distance (Dtgt) to a distance (Dbase×Kacc) larger than the base inter-vehicle distance (Dbase) (refer to a process of a step 370 in FIG. 3) and execute the following-travel inter-vehicle-distance control (refer to the processes of the steps 350 and 360 in FIG. 3) until the predetermined time (T1th+T2th+T3th) elapses (refer to the process of the step 517 in FIG. 5) when the electric control unit (10, 30, 40) determines that the driver is under the abnormal state (refer to the determinations “Yes” at the step 415 in FIG. 4 and the step 510 in FIG. 5 and a determination “No” at the step 330 in FIG. 3 and a determination “Yes” at a step 365 in FIG. 3) during the execution of the following-travel inter-vehicle-distance control (refer to the determinations “Yes” at the step 410 in FIG. 4 and the step 310 in FIG. 3).

With the invention apparatus, when the driver is determined to be under the abnormal state, the inter-vehicle distance between the own vehicle and the preceding vehicle is maintained at the increased distance larger than the base inter-vehicle distance. Therefore, after the driver is determined to be under the abnormal state, the inter-vehicle distance increases. At this time, if the driver is under the normal state, a possibility that the driver realizes an increasing of the inter-vehicle distance and operates the acceleration operator to decrease the inter-vehicle distance, is large. When the driver operates the acceleration operator, the driver is determined to be under the normal state and then, the forced stop control is stopped. Thus, the own vehicle can be prevented from being stopped unnecessarily when the driver is under the normal state.

In the invention apparatus, the increased distance (Dbase×Kacc) may be set to a distance which increases as the base inter-vehicle distance (Dbase) increases (refer to the process of the step 370 in FIG. 3).

When a difference between the base inter-vehicle distance and the increased distance, the driver may not realize the increasing of the inter-vehicle distance.

With the invention apparatus, when the driver is determined to be under the abnormal state, the target inter-vehicle distance increases as the base inter-vehicle distance increases. Therefore, when the driver is determined to be under the abnormal state while the inter-vehicle distance is maintained at a relatively long distance, the inter-vehicle distance increases substantially. Thus, the possibility that the driver realizes the increasing of the inter-vehicle distance, is large.

In the invention apparatus, the electric control unit (10, 30, 40) may be configured to determine that the driver is under a provisional abnormal state (refer to a process of a step 430 in FIG. 4) when the driver continues to be determined to be under the abnormal state for a predetermined provisional abnormal determination time (T1th) (refer to a determination “Yes” at a step 425 in FIG. 4), which is shorter than the predetermined time (T1th+T2th+T3th), after the electric control unit (10, 30, 40) determines that the driver is under the abnormal state (refer to the determination “Yes” at the step 415 in FIG. 4). In this case, the electric control unit (10, 30, 40) may be configured to set the target inter-vehicle distance (Dtgt) to the increased distance (Dbase×Kacc) (refer to the process of the step 370 in FIG. 3) and execute the following-travel inter-vehicle-distance control (refer to the processes of the steps 350 and 360) until the predetermined time (T1th+T2th+T3th) elapses when the electric control unit (10, 30, 40) determines that the driver is under the provisional abnormal state (refer to the determination “Yes” at the step 415 in FIG. 4) during the execution of the following-travel inter-vehicle distance control (refer to the determination “Yes” at the step 410 in FIG. 4).

In the invention apparatus, the electric control unit (10, 30, 40) may be configured to stop the following-travel inter-vehicle distance control and perform a deceleration control for decelerating the own vehicle (refer to the process of the step 520 in FIG. 5) when the driver continues to be determined to be under the abnormal state for a time (T1th+T2th) (refer to the determination “Yes” at the step 517 in FIG. 5), which is shorter than the predetermined time (T1th+T2th+T3th) and is longer than the provisional abnormal determination time (T1th), after the electric control unit (10, 30, 40) determines that the driver is under the abnormal state (refer to the determination “Yes” at the step 415 in FIG. 4).

In the above description, for facilitating understanding of the present invention, elements of the present invention corresponding to elements of an embodiment described later are denoted by reference symbols used in the description of the embodiment accompanied with parentheses. However, the elements of the present invention are not limited to the elements of the embodiment defined by the reference symbols. The other objects, features and accompanied advantages of the present invention can be easily understood from the description of the embodiment of the present invention along with the drawings.

### BRIEF DESCRIPTION OF THE DRAWINGS

FIG. 1 is a view for showing a general configuration of a vehicle traveling control apparatus according to an embodiment of the invention.

FIG. 2 is a view used for describing an operation of the vehicle traveling control apparatus shown in FIG. 1.

FIG. 3 is a flowchart for showing a following-travel inter-vehicle-distance control routine (i.e., an ACC routine) executed by a CPU of a driving assist ECU shown in FIG. 1.

FIG. 4 is a flowchart for showing a normal state routine executed by the CPU.

FIG. 5 is a flowchart for showing a provisional abnormal state routine executed by the CPU.

FIG. 6 is a flowchart for showing a conclusive abnormal state routine executed by the CPU.

FIG. 7 is a flowchart for showing a stop permission routine executed by the CPU.

### DESCRIPTION OF THE PREFERRED EMBODIMENTS

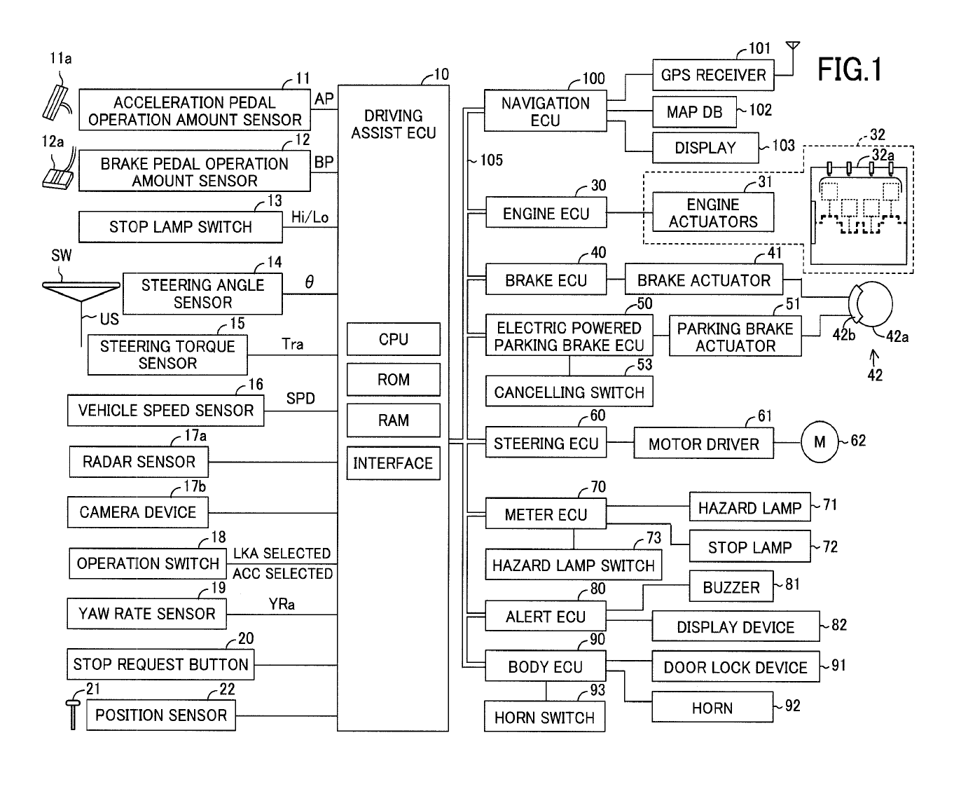

Below, with reference to the drawings, a vehicle traveling control apparatus (or a vehicle driving assist apparatus) according to an embodiment of the invention will be described. The vehicle traveling control apparatus according to the embodiment of the invention (hereinafter, will be referred to as “the embodiment apparatus”) is applied to a vehicle. Hereinafter, the vehicle will be referred to as “the own vehicle” in order to distinguish the vehicle, to which the embodiment apparatus is applied, from the other vehicles. As shown in FIG. 1, the embodiment apparatus includes a driving assist ECU 10, an engine ECU 30, a brake ECU 40, an electric powered parking brake ECU 50, a steering ECU 60, a meter ECU 70, an alert ECU 80, a body ECU 90 and a navigation ECU 100.

Each of the ECUs is an electric control unit including a microcomputer as a main part and the ECUs are connected to each other via a CAN (Controller Area Network) 105 such that the ECUs send and receive data to and from each other. In this description, the microcomputer includes a CPU, a ROM (a non-volatile memory), a RAM, an interface and the like. The CPU realizes various functions by executing instructions or programs or routines stored in the ROM. Some of the ECUs or all of the ECUs may be integrated to a single ECU.

The driving assist ECU 10 is electrically connected to sensors including switches described later and receives detection signals or output signals of the sensors, respectively. The sensors may be electrically connected to any of the ECUs other than the driving assist ECU 10. In this case, the driving assist ECU 10 receives the detection signals or the output signals of the sensors from the ECUs electrically connected to the sensors via the CAN 105.

An acceleration pedal operation amount sensor 11 detects an operation amount AP of an acceleration pedal 11a of the own vehicle and outputs a detection signal or an output signal representing the operation amount AP to the driving assist ECU 10. Hereinafter, the operation amount AP will be referred to as “the acceleration pedal operation amount AP”. A brake pedal operation amount sensor 12 detects an operation amount BP of a brake pedal 12a of the own vehicle and outputs a detection signal or an output signal representing the operation amount BP to the driving assist ECU 10. Hereinafter, the operation amount BP will be referred to as “the brake pedal operation amount BP”.

A stop lamp switch 13 outputs a low-level output signal to the driving assist ECU 10 when the brake pedal 12a is not depressed, that is, when the brake pedal 12a is not operated. On the other hand, the stop lamp switch 13 outputs a high-level output signal to the driving assist ECU 10 when the brake pedal 12a is depressed, that is, when the brake pedal 12a is operated.

A steering angle sensor 14 detects a steering angle θ of the own vehicle and outputs a detection signal or an output signal representing the steering angle θ to the driving assist ECU 10. A steering torque sensor 15 detects a steering torque Tra applied to a steering shaft US of the own vehicle by an operation of a steering wheel SW and outputs a detection signal or an output signal representing the steering torque Tra to the driving assist ECU 10. A vehicle speed sensor 16 detects a traveling speed SPD of the own vehicle and outputs a detection signal or an output signal representing the traveling speed SPD to the driving assist ECU 10. Hereinafter, the traveling speed SPD will be described as to “the vehicle speed SPD”.

A radar sensor 17a acquires information on a road in front of the own vehicle and three dimensional objects on the road. The three-dimensional objects include, for example, moving objects such as pedestrians, bicycles, vehicles and the like and motionless objects such as power poles, trees, guardrails and the like. Hereinafter, these three-dimensional objects will be referred to as “the target object”.

The radar sensor 17a includes a radar transmitting/receiving part (not shown) and a signal processing part (not shown). The radar transmitting/receiving part transmits radio waves each having a millimeter wave band to an area surrounding the own vehicle including an area in front of the own vehicle and receives the radio waves reflected by the target objects existing within a radiation range. Hereinafter, the radio wave having the millimeter wave band will be referred to as “the millimeter wave” and the radio wave reflected by the target object will be referred to as “the reflected wave”. The signal processing part acquires an inter-vehicle distance (i.e. a longitudinal distance), a relative vehicle speed, a lateral distance, a relative lateral vehicle speed and the like each time a predetermined time elapses on the basis of a phase difference between the transmitted millimeter wave and the received reflected wave, a damping level of the received reflected wave with respect to the transmitted millimeter wave, a time from a transmission of the millimeter wave to a reception of the reflected wave and the like.

A camera device 17b includes a stereo camera (now shown) and an image processing part (not shown). The stereo camera takes a pair of right and left images of landscapes at a right side of the own vehicle in front of the own vehicle and at a left side of the own vehicle in front of the own vehicle. The stereo camera acquires image data from the images of the landscapes at the right and left sides of the own vehicle. The image processing part determines whether or not the target object exists and calculates a relationship between the target object and the own vehicle and the like to output them on the basis of the image data of the images of the landscapes at the right and left sides of the own vehicle taken by the stereo camera.

The driving assist ECU 10 determines the relationship between the own vehicle and the target object, that is, determines target object information on the target object by combining the relationship between the own vehicle and the target object acquired by the radar sensor 17a and the relationship between the own vehicle and the target object acquired by the camera device 17b. Further, the driving assist ECU 10 realizes lane markers such as right and left lane lines provided on the road on the basis of the image data of the images of the landscapes at the right and left sides of the own vehicle taken by the camera device 17b and acquires a shape of the road such as a curvature radius of the road representing a degree of a curvature of the road, a positional relationship between the road and the own vehicle and the like. In addition, the driving assist ECU 10 acquires information on whether or not a road side wall exists on the basis of the image data acquired by the camera device 17b.

An operation switch 18 is operated by a driver of the own vehicle. The driver can control an execution of a lane keeping assist control (LKA) described later by operating the operation switch 18. Further, the driver can control an execution of a following-travel inter-vehicle-distance control such as an adaptive cruise control (ACC) described later by operating the operation switch 18.

A yaw rate sensor 19 detects a yaw rate YRa of the own vehicle and outputs a detection signal or an output signal representing the yaw rate YRa to the driving assist ECU 10.

A stop request button 20 is provided at a position which the driver can operates. When the stop request button 20 is not operated, the stop request button 20 outputs a low-level output signal to the driving assist ECU 10. On the other hand, when the stop request button 20 is operated, the stop request button 20 outputs a high-level output signal to the driving assist ECU 10.

The engine ECU 30 is electrically connected to engine actuators 31 of the engine 32. The engine actuators 31 change operation states of a body 32a of the engine 32, respectively. In this embodiment, the engine 32 is a gasoline-fuel-injection spark-ignition type multi-cylinder internal combustion engine and includes a throttle valve (not shown) for adjusting an amount of air flowing into combustion chambers (not shown) of the engine 32. The engine actuators 31 include at least a throttle valve actuator (not shown) for changing an opening degree of the throttle valve.

The engine ECU 30 can change the engine torque generated by the engine 32 by controlling activations of the engine actuators 31. The engine torque generated by the engine 32 is transmitted to drive wheels (not shown) of the own vehicle through a transmission (not shown). Therefore, the engine ECU 30 can change an acceleration or an acceleration state by controlling the driving force supplied to the own vehicle, in particular, to the drive wheels by controlling the activations of the engine actuators 31.

The brake ECU 40 is electrically connected to a brake actuator 41. The brake actuator 41 is provided in a hydraulic circuit provided between a master cylinder (not shown) for pressurizing hydraulic oil by a depression force of the brake pedal 12a and a friction brake mechanism provided in right and left front and rear wheels of the own vehicle. The friction brake mechanism 42 includes brake discs 42a each secured to the corresponding wheel of the own vehicle and brake calipers 42b secured to the body of the own vehicle at the corresponding wheel.

The brake actuator 41 adjusts a hydraulic pressure supplied to a wheel cylinder (not shown) in each of the brake caliper 42b, depending on a command sent from the brake ECU 40 to activate the wheel cylinder by the hydraulic pressure to press a brake pad (not shown) on the brake disc 42a, thereby to generate a friction braking force on the brake disc 42a. Therefore, the brake ECU 40 can control an activation of the brake actuator 41 to control a braking force applied to the own vehicle, in particular, to the wheels. Hereinafter, a braking of the own vehicle by controlling the activation of the brake actuator 41 will be referred to as “the hydraulic braking performed by the friction brake mechanism 42” or simply as “the hydraulic braking”.

The electric powered parking brake ECU 50 is electrically connected to a parking brake actuator 51. The parking brake actuator 51 generates the friction braking force by pressing the brake pad on the brake disc 42a. Alternatively, when the own vehicle includes drum brakes in the wheels of the own vehicle, respectively, the parking brake actuator 51 generates the friction braking force by pressing a shoe on a drum which rotates together with the corresponding wheel. Therefore, the electric powered parking brake ECU 50 can apply the friction braking force to the wheels by activating the parking brake actuator 51. Hereinafter, the braking of the own vehicle by activating the parking brake actuator 51 will be referred to as “the EPB braking”.

A canceling switch 53 is electrically connected to the electric powered parking brake ECU 50. When the cancelling switch 53 is operated, a stop of the EPB braking is requested to the electric powered parking brake ECU 50.

The steering ECU 60 is a control device of a known electric powered steering system and is electrically connected to a motor driver 61. The motor driver 61 is electrically connected to a steering motor 62. The steering motor 62 is assembled in a steering mechanism (not shown) of the own vehicle including the steering wheel SW, the steering shaft US connected to the steering wheel SW, a steering gear mechanism (not shown) and the like. The steering motor 62 generates a torque by an electric power supplied from the motor driver 61 and uses the torque to apply a steering assist torque to the steering shaft US to steer the right and left steered wheels.

The meter ECU 70 is electrically connected to a digital display meter (not shown), a hazard lamp 71 and a stop lamp 72. The meter ECU 70 blinks the hazard lamp 71 and lights the stop lamp 72, depending on a command sent from the driving assist ECU 10.

The meter ECU 70 is electrically connected to a hazard lamp switch 73. When the hazard lamp switch 73 is operated while the hazard lamp 71 does not blink, the driving assist ECU 10 requests the meter ECU 70 to blink the hazard lamp 71. On the other hand, when the hazard lamp switch 73 is operated while the hazard lamp 71 blinks, the driving assist ECU 10 requests the meter ECU 70 to stop a blinking of the hazard lamp 71.

The alert ECU 80 is electrically connected to a buzzer 81 and a display device 82. The alert ECU 80 can perform an attention to the driver by causing the buzzer 81 to generate sounds, depending on a command sent from the driving assist ECU 10. In addition, the alert ECU 80 can cause the display device 82 to light an attention mark such as a warning lamp and/or display an attention message and an operation state of a driving assist control. Hereinafter, a generation of the sounds performed by the buzzer 81, a lighting of the attention mark performed by the display device 82 and the like will be referred to as “the non-driving-operation alert”.

The body ECU 90 is electrically connected to a door lock device 91 and a horn 92. The body ECU 90 causes the door lock device 91 to release a lock of doors (not shown) of the own vehicle, depending on a command sent from the driving assist ECU 10. Further, the body ECU 90 causes the horn 92 to generate sounds, depending on a command sent from the driving assist ECU 10.

The body ECU 90 is electrically connected to a horn switch 93. When the horn switch 93 is operated while the horn 92 generates the sounds, a stop of a sound generation performed by the horn 92 is requested to the body ECU 90.

The navigation ECU 100 is electrically connected to a GPS receiver 101 which receives a GPS detection signal for detecting a present position of the own vehicle, a map database 102 which stores a map information and the like, a touch-screen type display 103 which is a human-machine interface and the like. The navigation ECU 100 identifies the present position of the own vehicle on the basis of the GPS detection signal, performs various calculations on the basis of the present position of the own vehicle and the map information and the like stored in the map database 102 and performs a route guidance using the display 103.

The map information stored in the map database 102 includes road information. The road information includes parameters which show a road shape of each of segments of the road such as a road curvature radius or a road curvature which shows a degree of a curve of the road. The curvature corresponds to an inverse number of the curvature radius.

<Summary of Operation of Embodiment Apparatus>

Next, a summary of an operation of the embodiment apparatus will be described. The driving assist ECU 10 of the embodiment apparatus is configured or programmed to execute the lane keeping control (LKA) and the following-travel inter-vehicle-distance control (ACC). Further, the driving assist ECU 10 determines whether or not the driver is under an abnormal state which the driver loses his/her ability of driving the own vehicle repeatedly when the lane keeping control and the following-travel inter-vehicle-distance control are executed. Hereinafter, the abnormal state which the driver loses his/her ability of driving the own vehicle will be simply referred to as “the abnormal state”. When the driver continues to be under the abnormal state at an elapse of a predetermined time from a time of first determining that the driver is under the abnormal state, the driving assist ECU 10 decelerates the own vehicle to stop the own vehicle.

Next, a summary of a process for stopping the own vehicle when the driver continues to be under the abnormal state will be described. In this regard, a determination of whether or not the driver is under the abnormal state is performed when a condition that the lane keeping control and the following-travel inter-vehicle-distance control are executed, is satisfied. Accordingly, the lane keeping control and the following-travel inter-vehicle-distance control will be described first.

<Lane Keeping Assist Control (LKA)>

The lane keeping control is a control for assisting a steering operation of the driver by applying the steering torque to the steering mechanism to keep the position of the own vehicle along a target traveling line within a lane, in which the own vehicle travels. Hereinafter, the lane, in which the own vehicle travels, will be referred to as “the traveling lane”. The lane keeping control is known (for example, refer to JP 2008-195402 A, JP 2009-190464 A, JP 2010-6279 A and JP 4349210 B). Therefore, below, the lane keeping control will be briefly described.

The driving assist ECU 10 identifies or acquire the right and left lane lines LR and LL of the traveling lane, on which the own vehicle travels, on the basis of the image data sent from the camera device 17b and determines a center position between the right and left lane lines LR and LL as a target traveling line Ld. Further, the driving assist ECU 10 calculates a curve radius, i.e., a curvature radius R of the target traveling line Ld and the position and a direction of the own vehicle in the traveling lane which is defined by the right and left lane lines LR and LL.

Then, the driving assist ECU 10 calculates a distance Dc between a front center position of the own vehicle and the target traveling line Ld in a lateral direction or width direction of the road and a difference angle θy between the target traveling line Ld and a traveling direction of the own vehicle. Hereinafter, the distance Dc will be referred to as “the center distance Dc” and the difference angle θy will be referred to as “the yaw angle θy”.

Further, the driving assist ECU 10 calculates a target yaw rate YRctgt at a predetermined calculation cycle on the basis of the center distance Dc, the yaw angle θy and the road curvature ν (=1/R) in accordance with a following expression (1). In the expression (1), K1, K2 and K3 are control gains. The target yaw rate YRctgt is a yaw rate which is set to cause the own vehicle to travel along the target traveling line Ld.

YRctgt=K1×Dc+K2×θy+K3×ν (1)

The driving assist ECU 10 calculates a target steering torque Trtgt for accomplishing the target yaw rate YRctgt at a predetermined calculation cycle on the basis of the target yaw rate YRctgt and the actual yaw rate YRa.

In particular, the driving assist ECU 10 previously stores a look-up table which defines a relationship between the target steering torque Trtgt and a difference between the target yaw rate YRctgt and the actual yaw rate YRa. The driving assist ECU 10 calculates the target steering torque Trtgt by applying the difference between the target yaw rate YRctgt and the yaw rate YRa to the look-up table. Then, the driving assist ECU 10 controls the steering motor 62 by using the steering ECU 60 such that the actual steering torque Tra corresponds to the target steering torque Trtgt. The summary of the lane keeping control has been described.

<Following-Travel Inter-Vehicle-Distance Control (ACC)>

The following-travel inter-vehicle-distance control is a control for causing the own vehicle to travel following a preceding vehicle which travels in front of the own vehicle while maintaining an inter-vehicle distance between the preceding vehicle and the own vehicle at a predetermined distance. The following-travel inter-vehicle-distance control is known (for example, JP 2014-148293 A, JP 2006-315491 A, JP 4172434 B and JP 4929777 B). Therefore, below, the following-travel inter-vehicle-distance control will be briefly described.

The driving assist ECU 10 executes the following-travel inter-vehicle-distance control when an execution of the following-travel inter-vehicle-distance control is requested by an operation of the operation switch 18.

In particular, the driving assist ECU 10 selects a vehicle, which the own vehicle should follow, on the basis of the target object information acquired by a surrounding sensor including the radar sensor 17a and the camera device 17b when the execution of the following-travel inter-vehicle-distance control is requested. The vehicle which the own vehicle should follow will be referred to as “the target vehicle”. For example, the driving assist ECU 10 determines whether or not a relative position of the target object (n) is within a target vehicle area. The relative position of the target object (n) is determined on the basis of the lateral distance Dfy(n) of the detected target object (n) and the inter-vehicle distance Dfx(n). The target vehicle area is an area previously determined such that the lateral distance Dfy(n) decreases as the inter-vehicle distance Dfx(n) increases. Then, when the relative position of the target object (n) is within the target vehicle area for a time equal to or longer than a predetermined time, the driving assist ECU 10 selects the target object (n) as the target vehicle (a).

Further, the driving assist ECU 10 calculates a target acceleration Gtgt in according with any of following expressions (2) and (3). In the expressions (2) and (3), Vfx(a) is a relative vehicle speed of the target vehicle (a) with respect to the own vehicle, k1 and k2 are predetermined positive gains or coefficients and ΔD1 is an inter-vehicle distance difference obtained by subtracting a target inter-vehicle distance Dtgt from the inter-vehicle distance Dfx(a) of the target vehicle (a) (ΔD1=Dfx(a)−Dtgt).

When the driver is determined not to be under the abnormal state, that is, the driver is determined to be under a normal state, the target inter-vehicle distance Dtgt is set to a base inter-vehicle distance Dbase obtained by multiplying a target inter-vehicle time Ttgt by the vehicle speed SPD of the own vehicle (Dtgt=Dbase=Ttgt×SPD). The target inter-vehicle time Ttgt is set by the driver using the operation switch 18.

On the other hand, when the driver is determined to be under the abnormal state, the target inter-vehicle distance Dtgt is set to an increased distance larger than the base inter-vehicle distance Dbase.

The driving assist ECU 10 determines the target acceleration Gtgt in accordance with the following expression (2) when the value (k1×ΔD1+k2×Vfx(a)) is positive or zero. In the expression (2), ka1 is a positive gain or coefficient for accelerating the own vehicle and is set to a value equal to or smaller than “1”.

Gtgt(for acceleration)=ka1×(k1×ΔD1+k2×Vfx(a)) (2)

On the other hand, when the value (k1×ΔD1+k2×Vfx(a)) is negative, the driving assist ECU 10 determines the target acceleration Gtgt in accordance with the following expression (3). In the expression (3), kd1 is a gain or coefficient for decelerating the own vehicle and in this embodiment, is set to “1”.

Gtgt(for deceleration)=kd1×(k1×ΔD1+k2×Vfx(a)) (3)

When the target vehicle does not exist within the target vehicle area, the driving assist ECU 10 determines the target acceleration Gtgt on the basis of the vehicle speed SPD of the own vehicle and a target vehicle speed SPDtgt such that the vehicle speed SPD of the own vehicle corresponds to the target vehicle speed SPDtgt which is set depending on the target inter-vehicle time Ttgt.

The driving assist ECU 10 controls the engine actuators 31 by using the engine ECU 30 and if necessary, controls the brake actuator 41 by using the brake ECU 40 such that an acceleration of the own vehicle corresponds to the target acceleration Gtgt. The summary of the following-travel inter-vehicle-distance control has been described.

<Process for Stopping Vehicle>

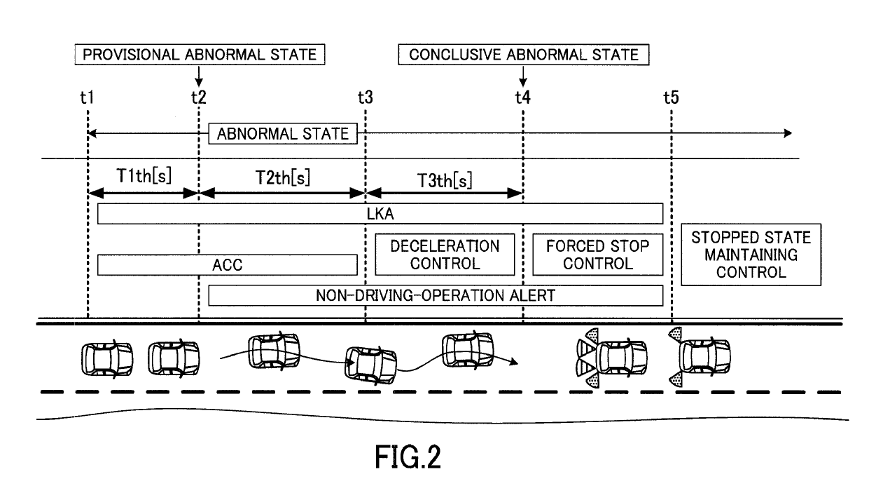

The driving assist ECU 10 provisionally determines that the driver is under the abnormal state at a time t2 in FIG. 2 when the driving assist ECU 10 has determined that driver is under the abnormal state for a predetermined time T1th from a time t1 in FIG. 2 when the driving assist ECU 10 first determines that the driver is under the abnormal state. Hereinafter, the predetermined time T1th will be referred to as “the first threshold time T1th” and the abnormal state which is provisionally determined will be referred to as “the provisional abnormal state”. When the driving assist ECU 10 first determines that the driver is under the provisional abnormal state, the driving assist ECU 10 changes a driver's state from a normal state, which has been set, to the provisional abnormal state. In this case, the driving assist ECU 10 performs an alerting for prompting the driver to perform driving operations.

n this case, the driving assist ECU 10 continues the lane keeping control and the following-travel inter-vehicle distance control. In the following-travel inter-vehicle distance control, as described above, the driving assist ECU 10 sets the target inter-vehicle distance Dtgt to the increased distance larger than the base inter-vehicle distance Dbase and executes the following-travel inter-vehicle distance control.

Thereby, the inter-vehicle distance Dfx(a) becomes larger than the inter-vehicle distance Dfx(a) accomplished when the driver is determined to be under the normal state. Therefore, when the driving assist ECU 10 determines that the driver is under the abnormal state, but actually, the driver is not under the abnormal state, the driver can be expected to realize that the inter-vehicle distance Dfx(a) increases and then, operates the acceleration pedal 11a.

When the driver operates the acceleration pedal 11a, the driving assist ECU 10 returns the driver's state from the provisional abnormal state to the normal state. In this case, the driving assist ECU 10 does not execute a forced stop control described later to stop the own vehicle. Thus, even when the driver under the normal state is determined to be under the abnormal state, the own vehicle can be prevented from being stopped unnecessarily.

When the driving assist ECU 10 determines that the driver is still under the abnormal state at a time t3 in FIG. 2 when a predetermined time T2th elapses from the time t2 when the driver's state is changed from the normal state to the provisional abnormal state, the driving assist ECU 10 stops the following-travel inter-vehicle-distance control and starts a deceleration control for decreasing the vehicle speed SPD of the own vehicle at a predetermined first constant deceleration α1 by the hydraulic braking performed by the friction brake mechanism 42. At this time, the driving assist ECU 10 continues the lane keeping control. Hereinafter, the predetermined time T2th will be referred to as “the second threshold time T2th”.

When the driver knows the alerting and/or the deceleration of the own vehicle and performs the driving operations, the driving assist ECU 10 detects the driver's driving operation and returns the driver's state from the provisional abnormal state to the normal state. In this case, the driving assist ECU 10 stops the alerting for the driver which has been performed and the deceleration control which have been executed. At this time, the driving assist ECU 10 continues the lane keeping control and restart the following-travel inter-vehicle-distance control.

On the other hand, after the driving assist ECU 10 starts the deceleration control, the driver does not perform any driving operations and then, when a predetermined time T3th elapses at a time t4 in FIG. 2 from the time t3 when the deceleration control starts, a possibility that the driver is under the abnormal state, is large. In this case, the driving assist ECU 10 changes the driver's state from the provisional abnormal state to a conclusive abnormal state. Hereinafter, the predetermined time T3th will be referred to as “the third threshold time T3th”.

Further, the driving assist ECU 10 forbids the acceleration including the deceleration of the own vehicle derived from a change of the acceleration pedal operation amount AP, that is, forbids an acceleration pedal operation overriding. In other words, the driving assist ECU 10 cancels or ignores a driving state changing request or an acceleration request derived from an operation of the acceleration pedal 11a as far as the driving operation of the driver is not detected.

Therefore, when the engine torque TQdriver requested by the driver deriving from an operation of the acceleration pedal 11a by the driver is larger than zero while the driving assist ECU 10 forbids the acceleration pedal operation override, the driving assist ECU 10 sets the engine torque TQreq actually requested for the engine ECU 30 to zero. In this case, the engine ECU 30 causes the engine 32 to generate the engine torque necessary to the minimum for maintaining an operation of the engine 32. Hereinafter, the acceleration pedal operation override will be referred to as “the AOR”, the engine torque TQreq will be referred to as “the actual request torque TQreq” and the engine torque necessary to the minimum for maintaining the operation of the engine 32 will be referred to as “the idling torque”.

In addition to a setting of the actual request torque TQreq, the driving assist ECU 10 decelerates the own vehicle at a predetermined second constant deceleration α2 larger than the predetermined first constant deceleration α1, thereby to forcibly stop the own vehicle by the hydraulic braking performed by the friction brake mechanism 42.

Hereinafter, a control for forcibly stopping the own vehicle by forbidding the AOR and decelerating the own vehicle at the predetermined second constant deceleration α2 when the driver's state is set to the conclusive abnormal state, will be also referred to as “the forced stop control”.

<Stopped State Maintaining Control>

The driving assist ECU 10 continues to forbid the AOR, starts a stopped state maintaining control for performing the EPB braking and stops the hydraulic braking performed by the friction brake mechanism 42 at a time t5 in FIG. 2 when the driving assist ECU 10 forcibly stops the own vehicle by the forced stop control. Thereby, after the own vehicle stops, the own vehicle is maintained at a stopped state.

Further, at a time when forcibly stopping the own vehicle by the forced stop control, the driving assist ECU 10 forbids a stop of the blinking of the hazard lamp 71 and a stop of the sound generation performed by the horn 92. Thereby, after the own vehicle stops, the hazard lamp 71 continues to blink and the horn 92 continues to generate the sounds.

<Stop of Stopped State Maintaining Control>

The driving assist ECU 10 stops the stopped state maintaining control when a stop of the stopped state maintaining control is requested deriving from an operation of the stop request button 20 during an execution of the stopped state maintaining control. In particular, the driving assist ECU 10 permits the AOR (i.e., cancels a forbidding of the AOR) and a stop of the EPB braking. Further, the driving assist ECU 10 permits a stop of the blinking of the hazard lamp 71 and a stop of the sound generation performed by the horn 92.

When the stop of the EPB braking deriving from the operation of the cancelling switch 53 while the stop of the EPB braking, the EPB braking is stopped. Further, when the hazard lamp switch 73 is operated while the stop of the blinking of the hazard lamp 71 is permitted, the blinking of the hazard lamp 71 is stopped. In addition, when the horn switch 93 is operated while the stop of the sound generation performed by the horn 92 is permitted, the sound generation performed by the horn 92 is stopped.

The summary of the operation of the embodiment apparatus has been described. With the operation of the embodiment apparatus, the vehicle can be forcibly stopped when the driver is under the abnormal state.

<Concrete Operation of Embodiment Apparatus>

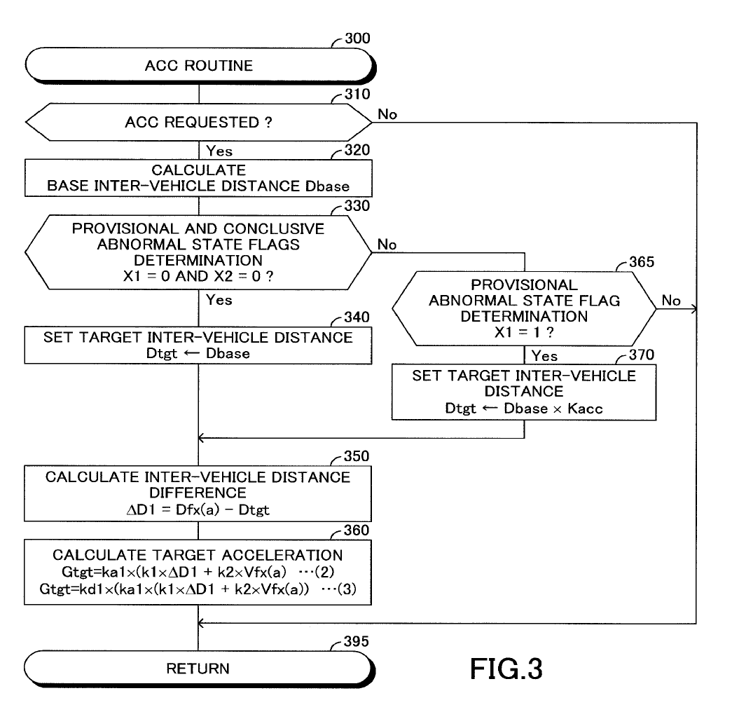

Next, a concrete operation of the embodiment apparatus will be described. The CPU of the driving assist ECU 10 of the embodiment apparatus is configured or programmed to execute a following-travel inter-vehicle-distance control routine (i.e., an ACC routine) shown by a flowchart in FIG. 3 each time a predetermined time dT elapses.

Therefore, at a predetermined timing, the CPU starts a process from a step 300 and then, proceeds with the process to a step 310 to determine whether or not an execution of the following-travel inter-vehicle-distance control (i.e., the ACC) is requested. When the execution of the following-travel inter-vehicle-distance control is requested, the CPU determines “Yes” at the step 310 and then, executes a process of step 320 described below. Then, the CPU proceeds with the process to a step 330.

Step 320: The CPU calculates the base inter-vehicle distance Dbase by multiplying the target inter-vehicle time Ttgt which the driver sets using the operation switch 18 by the vehicle speed SPD of the own vehicle (Dbase=Ttgt×SPD).

When the CPU proceeds with the process to the step 330, the CPU determines whether or not values of a provisional abnormal state flag X1 and a conclusive abnormal state flag X2 are “0”.

The provisional abnormal state flag X1 indicates that the driver's state is set to the provisional abnormal state when the value of the provisional abnormal state flag X1 is “1”. The conclusive abnormal state flag X2 indicates that the driver's state is set to the conclusive abnormal state when the value of the conclusive abnormal state flag X2 is “1”. When the values of the provisional and conclusive abnormal state flags X1 and X2 are “0”, the flags X1 and X2 indicate that the driver's state is set to the normal state.

The provisional and conclusive abnormal state flags X1 and X2 are initialized to “0”, respectively when an ignition switch is set to an ON position.

When the values of the provisional and conclusive abnormal state flags X1 and X2 are “0”, that is, when the driver is determined to be under the normal state, the CPU determines “Yes” at the step 330 and then, executes a process of a step 340 described below.

Step 340: The CPU sets the target inter-vehicle distance Dtgt to the base inter-vehicle distance Dbase calculated at the step 320.

On the other hand, when any of the values of the provisional and conclusive abnormal state flags X1 and X2 is “1” upon an execution of the process of the step 330, the CPU determines “No” at the step 330 and then, proceeds with the process to a step 365 to determine whether or not the value of the provisional abnormal state flag X1 is “1”.

When the value of the provisional abnormal state flag X1 is “1”, the CPU executes a process of a step 370 described below.

Step 370: The CPU sets the target inter-vehicle distance Dtgt to an increased distance obtained by multiplying the base inter-vehicle distance Dbase calculated at the step 320 by a correction coefficient Kacc larger than “1” (Dtgt=Dbase×Kacc). Thereby, the target inter-vehicle distance Dtgt is set to the increased distance larger than the target inter-vehicle distance Dtgt set at the step 340 when the driver is determined to be under the normal state.

After the CPU executes the process of the step 340 or 370, the CPU sequentially executes processes of steps 350 and 360 described below. Then, the CPU proceeds with the process to a step 395 to terminate this routine once.

Step 350: The CPU calculates an inter-vehicle distance difference ΔD1 by subtracting the target inter-vehicle distance Dtgt presently set from the actual inter-vehicle distance Dfx(a) (ΔD1=Dfx(a)−Dtgt). When the process of the step 350 is executed immediately after the process of the step 340 is executed, the target inter-vehicle distance Dtgt presently set is the target inter-vehicle distance Dtgt set at the step 340. When the process of the step 350 is executed immediately after the process of the step 370 is executed, the target inter-vehicle distance Dtgt presently set is the target inter-vehicle distance Dtgt set at the step 370.

Step 360: The CPU calculates the target acceleration Gtgt by using the inter-vehicle distance difference ΔD1 calculated at the step 350 and the actual inter-vehicle distance Dfx(a) in accordance with the expression (2) when the acceleration of the own vehicle is necessary. On the other hand, when the deceleration of the own vehicle is necessary, the CPU calculates the target acceleration Gtgt by using the inter-vehicle distance difference ΔD1 calculated at the step 350 and the actual inter-vehicle distance Dfx(a) in accordance with the expression (3).

When the following-travel inter-vehicle-distance control is not executed upon an execution of the step 310, the CPU determines “No” at the step 310 and then, proceeds with the process directly to the step 395 to terminate this routine once. When the value of the provisional abnormal state flag X1 is “0” upon an execution of the step 365, the CPU determines “No” at the step 365 and then, proceeds with the process directly to the step 395 to terminate this routine once.

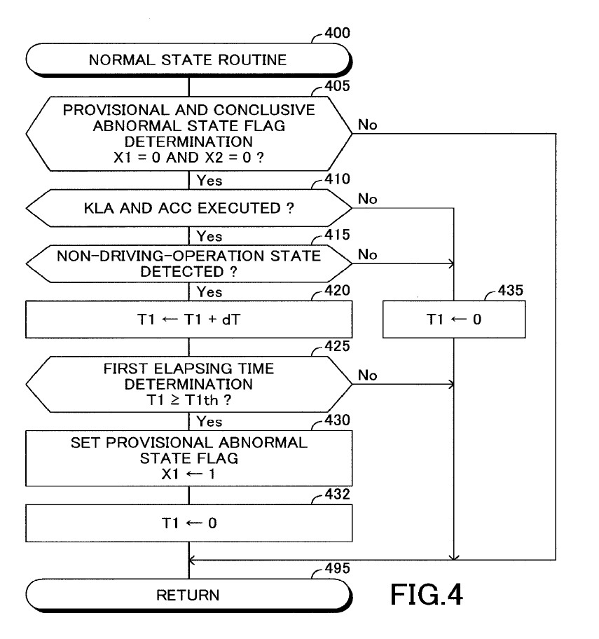

Further, the CPU is configured or programmed to execute a normal state routine shown by a flowchart in FIG. 4 each time a predetermined time dT elapses. Therefore, at a predetermined timing, the CPU starts a process of a step 400 in FIG. 4 and then, proceeds with the process to a step 405 to determine whether or not the values of the provisional and conclusive abnormal state flags X1 and X2 are “0”.

As described above, the provisional abnormal state flag X1 indicates that the driver's state is determined as the provisional abnormal state when the value of the provisional abnormal state flag X1 is “1”. The conclusive abnormal state flag X2 indicates that the driver's state is determined as the conclusive abnormal state when the value of the conclusive abnormal state flag X2 is “1”. When the values of the provisional and conclusive abnormal state flags X1 and X2 are “0”, the flags X1 and X2 indicate that the driver's state is determined as the normal state.

The values of the provisional and conclusive abnormal state flags X1 and X2 are initialized to be set to “0”, respectively when an ignition switch (not shown) is set at an ON position.

Immediately after the ignition switch is set at the ON position, the values of the provisional and conclusive abnormal state flags X1 and X2 are “0”. Thus, the CPU determines “Yes” at the step 405 and then, proceeds with the process to a step 410 to determine whether or not the lane keeping control (LKA) and the following-travel inter-vehicle-distance control (ACC) are executed.

When the lane keeping control and the following-travel inter-vehicle-distance control are executed, the CPU determines “Yes” at the step 410 and then, proceeds with the process to a step 415 to determine whether or not the non-driving-operation state that the driver does not take any driving action, is detected.

The non-driving-operation state is a state that one or more parameters such as the acceleration pedal operation amount AP, the brake pedal operation amount BP, the actual steering torque Tra and a signal level of the stop lamp switch 13 which are changed deriving from the driving operation of the driver, does/do not change. In this embodiment, the CPU determines a state that the acceleration pedal operation amount AP, the brake pedal operation amount BP and the actual steering torque Tra do not change and the actual steering torque Tra is zero as the non-driving-operation state.

When the non-driving-operation state is detected, the CPU determines “Yes” at the step 415 and then, executes a process of a step 420 described below. Then, the CPU proceeds with the process to a step 425.

Step 420: The CPU increases a time T1 elapsing from a time when the non-driving-operation state is first detected at the step 415 by a predetermined time dT. The predetermined time dT is equal to the predetermined time dT which corresponds to an execution cycle of this normal state routine. Hereinafter, the time T1 will be referred to as “the first elapsing time T1”.

When the CPU proceeds with the process to the step 425, the CPU determines whether or not the first elapsing time T1 is equal to or larger than the first threshold time T1th. Immediately after the CPU determines “Yes” at the step 415, the first elapsing time T1 is smaller than the first threshold time T1th. In this case, the CPU determines “No” at the step 425 and then, proceeds with the process to a step 495 to terminate this routine once.

On the other hand, when the non-driving-operation state continues and then, the first elapsing time T1 becomes equal to or larger than the first threshold time T1th, the CPU determines “Yes” at the step 425 and then, sequentially executes processes of steps 430 and 432 described below. Then, the CPU proceeds with the process to the step 495 to terminate this routine once.

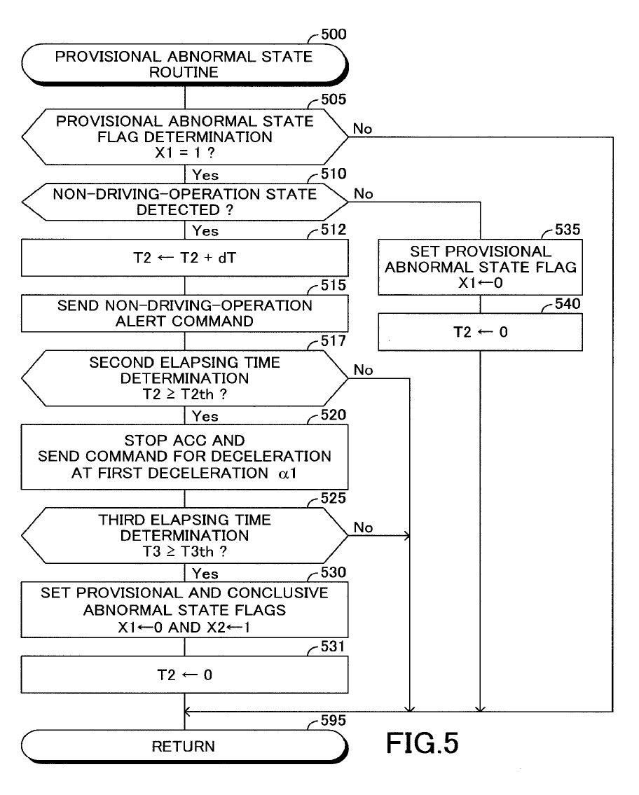

Step 430: The CPU sets the value of the provisional abnormal state flag X1 to “1”. After the value of the provisional abnormal state flag X1 is set to “1”, the CPU determines “No” at the step 405 and determines “Yes” at a step 505 in FIG. 5 described later. Therefore, in place of the normal state routine shown in FIG. 4, a provisional abnormal state routine shown in FIG. 5 substantially functions.

Step 432: The CPU clears the first elapsing time T1. The first elapsing time T1 is also cleared when the ignition switch is set at the ON position.

When any of the lane keeping control and the following-travel inter-vehicle-distance control is not executed upon an execution of the process of the step 410, the CPU determines “No” at the step 410 and then, executes a process of a step 435 described below. Also, when the non-driving-operation state is not detected upon an execution of the process of the step 415, the CPU determines “No” at the step 415 and then, executes the process of the step 435. Then, the CPU proceeds with the process to the step 495 to terminate this routine once.

Step 435: The CPU clears the first elapsing time T1.

When any of the values of the provisional and conclusive abnormal state flags X1 and X2 is “1” upon an execution of the process of the step 405, the CPU determines “No” at the step 405 and then, proceeds with the process directly to the step 495 to terminate this routine once.

Further, the CPU is configured or programmed to execute a provisional abnormal state routine shown by a flowchart in FIG. 5 each time the predetermined time dT elapses. Therefore, at a predetermined timing, the CPU starts a process from a step 500 in FIG. 5 and then, proceeds with the process to a step 505 to determine whether or not the value of the provisional abnormal state flag X1 is “1”. When the value of the provisional abnormal state flag X1 is set to “1” at the step 430 in FIG. 4, that is, when the driver's state is determined as the provisional abnormal state, the CPU determines “Yes” at the step 505 and then, proceeds with the process to a step 510.

When the CPU proceeds with the process to the step 510, the CPU determines whether or not the non-driving-operation state is detected. This determination is the same as the determination of the step 415 in FIG. 4. When the non-driving-operation state is detected, the CPU determines “Yes” at the step 510 and then, sequentially executes processes of steps 512 and 515 described below. Then, the CPU proceeds with the process to a step 517.

Step 512: The CPU increases a time T2 elapsing from a time when the driver's state is determined as the provisional abnormal state by the predetermined time dT. The predetermined time dT is equal to the predetermined time dT which corresponds to an execution cycle of this provisional abnormal routine. Hereinafter, the time T2 will be referred to as “the second elapsing time T2”.

Step 515: The CPU sends a non-driving-operation alert command to the alert ECU 80. Thereby, the alert ECU 80 causes the buzzer 81 to generate alerting sounds and causes the display device 82 to blink the warning lamp and display the alerting message for prompting the driver to operate any of the acceleration pedal 11a, the brake pedal 12a and the steering wheel SW.

When the CPU proceeds with the process to the step 517, the CPU determines whether or not the second elapsing time T2 is equal to or larger than the second threshold time T2th. Immediately after the value of the provisional abnormal state flag X1 is set to “1” at the step 430 in FIG. 4, that is, when the driver's state is determined as the provisional abnormal state, the second elapsing time T2 is smaller than the second threshold time T2th. In this case, the CPU determines “No” at the step 517 and then, proceeds with the process to a step 595 to terminate this routine once.

On the other hand, when the driver's state continues to be determined as the provisional abnormal state and then, the second elapsing time T2 becomes equal to or larger than the second threshold time T2th, the CPU determines “Yes” at the step 517 and then, executes a process of a step 520 described below. Then, the CPU proceeds with the process to a step 525.

Step 520: The CPU stops the following-travel inter-vehicle-distance control (ACC) and sends, to the engine and brake ECUs 30 and 40, a command for causing the engine and brake ECUs 30 and 40 to execute the deceleration control for decelerating the own vehicle at the predetermined first constant deceleration α1. In this case, the CPU calculates the acceleration of the own vehicle on the basis of a change amount per unit time of the vehicle speed SPD acquired on the basis of the detection signal sent from the vehicle speed sensor 16 and sends, to the engine and brake ECUs 30 and 40, a command for causing the calculated acceleration to correspond to the predetermined first constant deceleration α1. In this embodiment, the predetermined first constant deceleration α1 is set to a deceleration having an extremely small absolute value.

When the CPU proceeds to the process to the step 525, the CPU determines whether or not a time T3 elapsing from a time when the deceleration control is started at the step 520 is equal to or larger than the third threshold time T3th. The time T3 is acquired by subtracting the second threshold time T2th from the second elapsing time T2 (T3=T2−T2th). Hereinafter, the time T3 will be referred to as “the third elapsing time T3”.

Immediately after the process of the step 520 is first executed, that is, immediately after the deceleration control is started, the third elapsing time T3 is smaller than the third threshold time T3th. In this case, the CPU determines “No” at the step 525 and then, proceeds with the process to the step 595 to terminate this routine once.

On the other hand, when the driver's state continues to be determined as the provisional abnormal state and then, the third elapsing time T3 becomes equal to or larger than the third threshold time T3th, the CPU determines “Yes” at the step 525 and then, sequentially executes processes of steps 530 and 531 described below. Then, the CPU proceeds with the process to the step 595 to terminate this routine once.

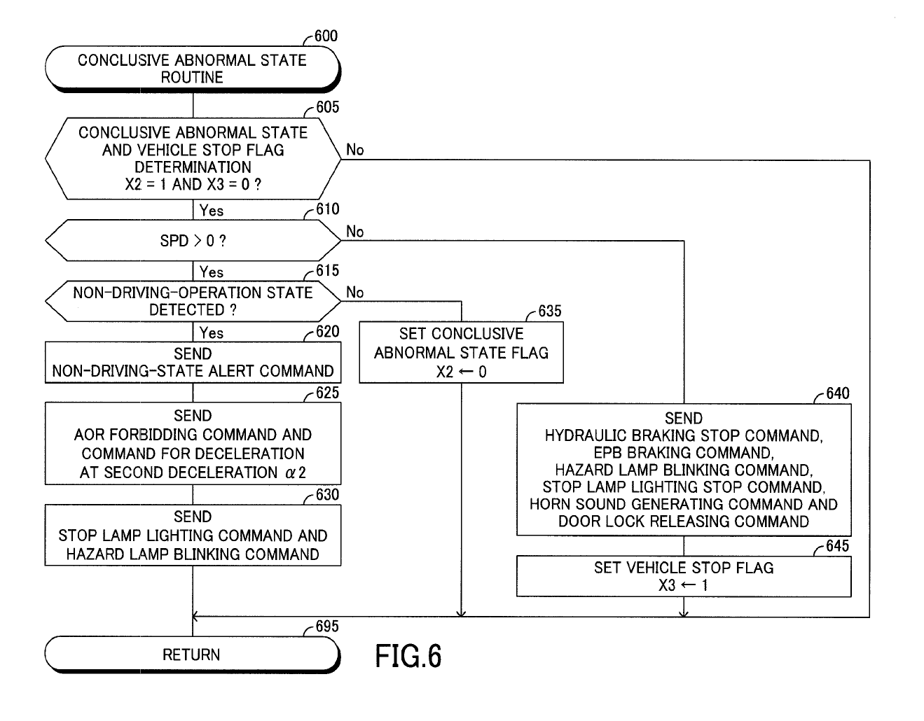

Step 530: The CPU sets the value of the provisional abnormal state flag X1 to “0” and sets the value of the conclusive abnormal state flag X2 to “1”. Thereby, the CPU determines “No” at the step 505 and determines “Yes” at a step 605 in FIG. 6 described later. In this case, in place of the provisional abnormal state routine shown in FIG. 5, a conclusive abnormal state routine shown in FIG. 6 substantially functions.

Step 531: The CPU clears the second elapsing time T2. The second elapsing time T2 is also cleared when the ignition switch is set at the ON position.

When the driving operation by the driver is detected upon an execution of the process of the step 510, the CPU determines “No” at the step 510 and then, sequentially executes processes of steps 535 and 540 described below. Then, the CPU proceeds with the process to the step 595 to terminate this routine once.

Step 535: The CPU sets the value of the provisional abnormal state flag X1 to “0”. Thereby, the values of the provisional and conclusive abnormal state flags X1 and X2 are set to “0”, the driver's state is set to the normal state. In this case, the CPU determines “Yes” at the step 405 in FIG. 4. Thus, in place of the provisional abnormal state routine shown in FIG. 5, the normal state routine shown in FIG. 4 substantially functions.

Step 540: The CPU clears the second elapsing time T2.

Further, when the value of the provisional abnormal state flag X1 is “0” upon an execution of the process of the step 505, the CPU determines “No” at the step 505 and then, proceeds with the process directly to the step 595 to terminate this routine once.

Further, the CPU is configured or programmed to execute a conclusive abnormal state routine shown by a flowchart in FIG. 6 each time the predetermined time dT elapses. Therefore, at a predetermined timing, the CPU starts a process from a step 600 in FIG. 6 and then, proceeds with the process to a step 605 to determine whether or not the value of the conclusive abnormal flag X2 is “1”. When the value of the conclusive abnormal flag X2 is set to “1” at the step 530 in FIG. 5, the CPU determines “Yes” at the step 605 and then, proceeds with the process to a step 610.

When the CPU proceeds with the process to the step 610, the CPU determines whether or not the vehicle speed SPD is larger than zero, that is, the own vehicle travels. When the process of the step 610 is first executed, the own vehicle does not stop. In this case, the CPU determines “Yes” at the step 610 and then, proceeds with the process to a step 615.

When the CPU proceeds with the process to the step 615, the CPU determines whether or not the non-driving-operation state is detected. The process of the step 615 may be the same as the processes of the step 415 in FIG. 4 and the step 510 in FIG. 5 or may be configured to additionally include a condition that the driving operation is surely detected.

When the non-driving-operation state is detected, the CPU determines “Yes” at the step 615 and then, sequentially executes processes of steps 620 to 630 described below. Then, the CPU proceeds with the process to a step 695 to terminate this routine once.

Step 620: The CPU sends the non-driving-operation alert command to the alert ECU 80. Thereby, the alert ECU 80 performs the non-driving-operation alert by using the buzzer 81 and the display device 82. The non-driving-operation alert performed at the step 620 may be the same as the non-driving-operation alert performed at the step 515 in FIG. 5 or may be configured such that a level of the alerting increases, compared with the non-driving-operation alert performed at the step 515 (for example, a level of the sound generated by the buzzer 81 increases).

Step 625: The CPU sends a command for forbidding the AOR to the engine ECU 30 and sends, to the brake ECU 40, a command for decelerating the own vehicle at the predetermined second constant deceleration α2.

In this case, the forced stop control is executed. In particular, the engine ECU 30 sets the actual request torque TQreq requested for the engine 32 to zero, independently of a value of the acceleration pedal operation amount AP (i.e., a value of the driver request torque TQdriver, a value of the driver request driving force) and activates the engine actuators 31 such that the engine torque output from the engine 32 corresponds to the idling torque.

The brake ECU 40 activates the brake actuator 41 such that the own vehicle is decelerated at the predetermined second constant deceleration α2. In this embodiment, the predetermined second constant deceleration α2 is set to a value having an absolute value larger than an absolute value of the predetermined first constant deceleration α1.

Step 630: The CPU sends, to the meter ECU 70, a lighting command for lighting the stop lamp 72 and a blinking command for blinking the hazard lamp 71. Thereby, the meter ECU 70 lights the stop lamp 72 and blinks the hazard lamp 71. Thereby, a driver of a vehicle following the own vehicle can be alerted.

The driving assist ECU 10 decelerates the own vehicle by executing the aforementioned processes repeatedly.

When the driving operation of the driver is detected upon an execution of the process of the step 615, the CPU determines “No” at the step 615 and then, executes a process of a step 635 described below. Then, the CPU proceeds with the process to the step 695 to terminate this routine once.

Step 635: The CPU sets the value of the conclusive abnormal state flag X2 to “0”. Thereby, the deceleration control, the alerting for the driver of the own vehicle and the alerting for the driver of the vehicle following the own vehicle are stopped and a normal vehicle control for controlling the traveling of the own vehicle only on the basis of the driving operation of the driver of the own vehicle is started. Therefore, the lane keeping control and the following-travel inter-vehicle-distance control are executed, depending on a setting state of the operation switch 18.

The CPU may be configured or programmed not to execute the process of the step 635 when the driving operation of the driver of the own vehicle is detected during the execution of the forced stop control. For example, when the driving operation of the driver of the own vehicle is detected during the execution of the forced stop control, the CPU may be configured or programmed to continue to decelerate the own vehicle at the predetermined second constant deceleration α2 while forbidding the AOR and set the value of the conclusive abnormal state flag X2 to “0” after the own vehicle stops.

When no detection of the driving operation of the driver continues and then, the own vehicle is stopped by the deceleration at the predetermined second constant deceleration α2, that is, the vehicle speed SPD of the own vehicle becomes zero, the CPU determines “No” at the step 610 and then, sequentially executes processes of steps 640 to 645 described below. Then, the CPU proceeds with the process to the step 695 to terminate this routine once.

Step 640: The CPU sends a hydraulic braking stop command to the brake ECU 40, sends an EPB braking command to the electric powered parking brake ECU 50, sends a hazard lamp blinking command and a stop lamp lighting stop command to the meter ECU 70 and sends a horn sound generating command and a door lock releasing command to the body ECU 90.

When receiving the hydraulic braking stop command, the brake ECU 40 stops the hydraulic braking performed by the friction brake mechanism 42. When receiving the EPB braking command, the electric powered parking brake ECU 50 performs the EPB braking by activating the parking brake actuator 51. When receiving the hazard lamp blinking command and the stop lamp lighting stop command, the meter ECU 70 blinks the hazard lamp 71 and stops the lighting of the stop lamp 72. When receiving the horn sound generating command and the door lock releasing command, the body ECU 90 causes the horn 92 to generate the sounds and causes the door lock device 91 to release the door lock.

Step 645: The CPU sets the value of the vehicle stop flag X3 to “1”. The vehicle stop flag X3 indicates that the own vehicle is forcibly stopped by the forced stop control when the value of the vehicle stop flag X3 is “1”.

<Stop Permission Routine>

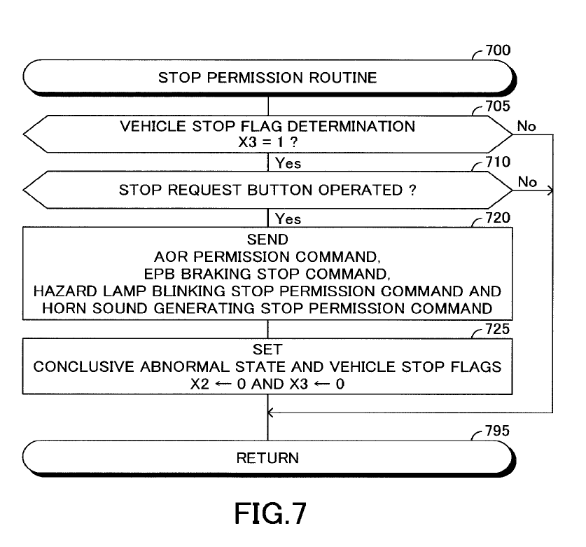

Further, the CPU configured or programmed to execute a stop permission routine shown by a flowchart in FIG. 7 each time the predetermined time dT elapses. Therefore, at a predetermined timing, the CPU starts a process from a step 700 in FIG. 7 and then, proceeds with the process to a step 705 to determine whether or not the value of the vehicle stop flag X3 is “1”. When the value of the vehicle stop flag X3 is “1”, the CPU determines “Yes” at the step 705 and then, proceeds with the process to a step 710 to determine whether or not the stop request button 20 is operated after the own vehicle is stopped by the process of the step 625 in FIG. 6.

When the stop request button 20 is operated after the own vehicle is stopped, the CPU determines “Yes” at the step 710 and then, sequentially executes processes of steps 720 and 725 described below. Then, the CPU proceeds with the process to a step 795 to terminate this routine once.

Step 720: The CPU sends an AOR permission command to the engine ECU 30, sends an EPB braking stop permission command to the electric powered parking brake ECU 50, sends a hazard lamp blinking stop permission command to the meter ECU 70 and sends a horn round generating stop permission command to the body ECU 90.

Further, the CPU is configured or programmed to execute a stop permission routine shown by a flowchart in FIG. 7 each time the predetermined time dT elapses. Therefore, at a predetermined timing, the CPU start a process from a step 700 and then, proceeds with the process to a step 705 to determine whether or not the value of the vehicle stop flag X3 is “1”. When the value of the vehicle stop flag X3 is “1”, the CPU determines “Yes” at the step 705 and then, proceeds with the process to a step 710 to determine whether or not the stop request button 20 is operated after the own vehicle is stopped by the process of the step 625 in FIG. 6.

When the stop request button 20 is operated after the own vehicle is stopped, the CPU determines “Yes” at the step 710 and then, sequentially executes processes of steps 720 and 725 described below. Then, the CPU proceeds with the process to a step 795 to terminate this routine once.

Step 720: The CPU sends an AOR permission command to the engine ECU 30, sends an EPB braking stop permission command to the electric powered parking brake ECU 50, sends a hazard lamp blinking stop permission command to the meter ECU 70 and sends a horn sound generating stop permission command to the body ECU 90.

When receiving the AOR permission command, the engine ECU 30 permits the AOR. When receiving the EPB braking stop permission command, the electric powered parking brake ECU 50 stops the EPB braking deriving from the operation of the cancelling switch 53. When receiving the hazard lamp blinking stop permission command, the meter ECU 70 stops the blinking of the hazard lamp 71 deriving from the operation of the hazard lamp switch 73. When receiving the horn sound generating stop permission command, the body ECU 90 stops the sound generation performed by the horn 92 deriving from the operation of the horn switch 93.

Step 725: The CPU sets the values of the conclusive abnormal state and vehicle stop flags X2 and X3 to “0”, respectively.

When the value of the vehicle stop flag X3 is “0” upon an execution of the process of the step 705, the CPU determines “No” at the step 705 and then, proceeds with the process directly to the step 795 to terminate this routine once. Also, when the stop request button 20 is not operated upon an execution of the process of the step 710, the CPU determines “No” at the step 710 and then, proceeds with the process directly to the step 795 to terminate this routine once.

The concrete operation of the embodiment apparatus has been described. With the routines shown in FIGS. 3 to 6, when the driver is under the abnormal state that the driver loses his/her ability of driving the own vehicle (refer to the determination “Yes” at the step 615 in FIG. 6), the own vehicle is braked to be stopped (refer to the process of the step 625 in FIG. 6).

Further, when the driver's state is set to the provisional abnormal state (refer to the determination “No” at the step 330 in FIG. 3 and the determination “Yes” at the step 365 in FIG. 3), the target inter-vehicle distance Dtgt is set to the increased distance (Dbase×Kacc) larger than the base inter-vehicle distance Dbase (refer to the process of the step 370 in FIG. 3). Thereby, the inter-vehicle distance Dfx(a) is larger than the inter-vehicle distance Dfx(a) accomplished when the driver is determined to be under the normal state. Therefore, when the driver under the normal state is determined to be under the abnormal state, the driver can be expected to realize the increasing of the inter-vehicle distance Dfx(a) and operate the acceleration pedal 11a.

When the driver operates the acceleration pedal 11a (refer to the determination “No” at the step 510 in FIG. 5), the own vehicle is not stopped by the forced stop control. Thus, even when the driver under the normal state is determined to be under the abnormal state, the own vehicle can be prevented from being stopped unnecessarily.

t should be noted that the present invention is not limited to the aforementioned embodiment and various modifications can be employed within the scope of the present invention.

The embodiment apparatus performs the abnormal determination of the driver on the basis of the time of the continuation of the non-driving-operation state, however the embodiment apparatus may be configured or programmed to perform the abnormal determination of the driver by using so-called driver monitor technique, for example, described in JP 2013-152700. In this case, a camera for taking an image of the driver of the own vehicle is provided on a member (for example, the steering wheel, a pillar and the like) inside the own vehicle. The driving assist ECU 10 monitors a direction of a line of sight of the driver or the face of the driver by using the image taken by the camera. The driving assist ECU 10 determines that the driver is under the abnormal state when the direction of the line of the sight of the driver or the face of the driver continues to be a direction which the line of the sight of the driver or the face of a driver under the normal state does not direct for over a predetermined time. This abnormal state determination using the image taken by the camera can be used for the determination of the provisional abnormal state (refer to the process of the step 415 in FIG. 4) and the determination of the conclusive abnormal state (refer to the process of the step 510 in FIG. 5).

Further, the embodiment apparatus sets the target inter-vehicle distance Dtgt at the step 370 in FIG. 3 such that the target inter-vehicle distance Dtgt increases as the base inter-vehicle distance Dbase increases. In this regard, the embodiment apparatus may be configured or programmed to set the target inter-vehicle distance Dtgt to an increased distance obtained by adding a constant distance to the base inter-vehicle distance Dbase independently of a magnitude of the base inter-vehicle distance Dbase.

What is claimed is:

1. A vehicle traveling control apparatus for executing a following-travel inter-vehicle-distance control for controlling acceleration and deceleration of an own vehicle, to which the vehicle traveling control apparatus is applied, such that an inter-vehicle distance between the own vehicle and a preceding vehicle traveling in front of the own vehicle is maintained at a target inter-vehicle distance,
the vehicle traveling control apparatus comprising an electric control unit configured:
to continuously determine whether or not a driver of the own vehicle is under an abnormal state that the driver loses an ability of driving the own vehicle during an execution of the following-travel inter-vehicle-distance control;
to stop the following-travel inter-vehicle-distance control and execute a forced stop control for stopping the own vehicle by braking the own vehicle when the driver continues to be determined to be under the abnormal state for a predetermined time after the electric control unit determines that the driver is under the abnormal state; and
to determine that the driver is under a normal state when an acceleration operator of the own vehicle is operated after the electric control unit determines that the driver is under the abnormal state,
wherein the electric control unit is configured:
to set the target inter-vehicle distance to a base inter-vehicle distance and execute the following-travel inter-vehicle-distance control when the electric control unit determines that the driver is not under the abnormal state during the execution of the following-travel inter-vehicle control; and
to set the target inter-vehicle distance to an increased distance larger than the base inter-vehicle distance and execute the following-travel inter-vehicle-distance control until the predetermined time elapses when the electric control unit determines that the driver is under the abnormal state during the execution of the following-travel inter-vehicle distance control.

2. The vehicle traveling control apparatus according to claim 1, wherein the increased distance is set to a distance which increases as the base inter-vehicle distance increases.

3. The vehicle traveling control apparatus according to claim 1, wherein the electric control unit is configured:
to determine that the driver is under a provisional abnormal state when the driver continues to be determined to be under the abnormal state for a predetermined provisional abnormal determination time, which is shorter than the predetermined time, after the electric control unit determines that the driver is under the abnormal state; and
to set the target inter-vehicle distance to the increased distance and execute the following-travel inter-vehicle-distance control until the predetermined time elapses when the electric control unit determines that the driver is under the provisional abnormal state during the execution of the following-travel inter-vehicle distance control.

4. The vehicle traveling control apparatus according to claim 3, wherein the electric control unit is configured to stop the following-travel inter-vehicle distance control and perform a deceleration control for decelerating the own vehicle when the driver continues to be determined to be under the abnormal state for a time, which is shorter than the predetermined time and is longer than the provisional abnormal determination time, after the electric control unit determines that the driver is under the abnormal state.
